(19) United States
(12) Patent Application Publication
(10) Pub. No.: US 2026/0299881 A1
(43) Pub. Date: Oct. 1, 2026

(54) MIXED PRECISION TRANSFORMER WITH INTEGER MULTIPLY ACCUMULATE

(71) Applicant: Tesla, Inc., Austin, TX (US)

(72) Inventors: Ritvik RAWAT, Sunnyvale, CA (US); Valeriy ROTAN, Los Gatos, CA (US); Alex SINGH, Austin, TX (US); Srihari SAMPATHKUMAR, Palo Alto, CA (US)

(73) Assignee: Tesla, Inc., Austin, TX (US)

(21) Appl. No.: 19/322,393

(22) Filed: Sep. 8, 2025

Related U.S. Application Data
(60) Provisional application No. 63/780,053, filed on Mar. 28, 2025.

(51) Int. Cl. G06F 7/499; G06N 3/0455

(52) U.S. Cl. CPC G06F 7/49942; G06N 3/0455

(57) ABSTRACT

Embodiments include systems and methods for processing sensor data and generating operational instructions for automated devices. The automated device includes hardware (e.g., INT8 MAC units, FP32 SIMD processors) and software operations executing a machine-learning architecture having transformer architectures implementing mixed-precision quantization for ingesting and analyzing various types of sensor data. The machine-learning architecture implements a transformer that includes dynamic quantization layers that dynamically quantize tensors, per-token, for downstream operations of the transformer and machine-learning architecture.

### CROSS-REFERENCE TO RELATED APPLICATION

This application claims priority to U.S. Provisional Application No. 63/780,053, filed Mar. 28, 2025, which is incorporated by reference in its entirety.

### TECHNICAL FIELD

The present application relates generally to neural network architecture for automated devices, and more specifically to a system and method for processing sensor data and for automated devices.

### BACKGROUND

Transformer architectures play a significant role in applications such as signal processing, robotics, autonomous vehicles, computer vision, and object recognition. Despite the importance of transformers, several challenges impede the effectiveness in various settings.

Adapting to dynamic input ranges presents a notable challenge for transformer models. Quantization errors further complicate their application, leading to reduced accuracy. Memory bandwidth limitations restrict data transfer rates, thereby hindering performance. High power consumption remains a persistent issue, affecting efficiency. Specialized hardware platforms often exhibit suboptimal performance when running transformer-based models. The lack of flexibility across different models limits adaptability. Maintaining high precision in residual streams is another concern, impacting model reliability. Complexity in generating quantization scale factors adds an additional layer of difficulty.

To address these issues, advanced and efficient quantization frameworks are required to enhance the performance of transformer-based models on specialized hardware platforms.

### SUMMARY

Disclosed herein is a mixed-precision quantization framework for transformer architectures, addressing several technological shortcomings, by optimizing for accelerators equipped with, for example, integer Multiply-Accumulate (MAC) units and Single Instruction, Multiple Data (SIMD) processors, such as 4-bit integer (INT 4), 8-bit integer (INT8), or 16-bit integer (INT16) MAC units, and 32-bit floating point (FP32) SIMD processors. The machine-learning architecture implementing a transformer includes dynamic quantization layers that dynamically quantize tensors per token or per channel, adapting to varying input ranges and preserving model accuracy with efficiency-focused quantization. This framework enhances memory bandwidth utilization, reduces energy consumption, and accelerates inference times, making transformer models robust and efficient for specialized hardware platforms. Additionally, embodiments leverage high-throughput datatypes and normalization techniques for various transformer-based models.

Embodiments may include a method including: obtaining, by a processor, input data having a number of bits according to a first precision and including one or more tokens; determining, by the processor, a second precision as a level of precision for input to a next computation operation of a neural network architecture; for each particular token of the one or more tokens of the input data: generating, by the processor, a token scale factor based on a range of values associated with the token; and executing, by the processor, a quantization operation on the token of the input data using the token scale factor to update the token of the input data from the first precision to a quantized token having the second precision for the level of precision for the next computation operation; and generating, by the processor, output data by executing the next computation operation using each quantized token having the number of bits according to the second precision.

The method may include generating, by the processor, a channel scale factor for each channel of one or more channels of a tensor; and for each channel of the tensor, applying, by the processor, the channel scale factor according to the second precision. The method may include, for each channel of the one or more channels of the tensor: determining, by the processor, a maximum absolute value amongst a plurality of values of the input data in the channel; and determining, by the processor, the channel scale factor based upon a range of values amongst the plurality of values of the input data in the channel using the maximum absolute value of the input data in the channel.

The method may include determining, by the processor, the level of precision for the input data based on at least one of: a signal-to-noise ratio of the input data, a loss function associated with a training process of the neural network architecture, or a computational constraint of a hardware accelerator. The method may include extracting, by the processor, the one or more tokens from the input data.

The method may include, during a training phase of the neural network architecture: obtaining, by the processor, a training data having the first precision; executing, by the processor, the quantization operation on the training data according to the second precision to update the number of bits of the training data from the first precision to the second precision; generating, by the processor, predicted output data of the next computation operation based upon the training data, by executing the next computation operation using the training data having the number of bits according to the second precision; and updating, by the processor, one or more parameters of the neural network architecture having the next computation operation based on a loss value between the predicted output data and a training label associated with the training data.

The processor may execute the next computation operation using an accelerator including at least one of a MAC unit or a SIMD processor.

The method may include generating, by the processor, a plurality of data blocks from the input data based upon a tiling configuration of a tensor along one or more dimensions of the tensor, each data block of the input data includes a subset of values within the tensor defined along the one or more dimensions of the tensor; and for each data block of the plurality of data blocks, applying, by the processor, a block scale factor to the data block based upon a range of values amongst the subset of values of the data block according to the second precision.

The method may include, for each data block of the plurality data blocks: determining, by the processor, a maximum absolute value amongst the subset of values of the input data in the data block; and determining, by the processor, the block scale factor based upon the range of values amongst the subset of values of the input data in the data block using the maximum absolute value of the data block.

The method may include storing, by the processor, each token scale factor into a non-transitory machine-readable storage.

Embodiments may include a system including a processor. The processor may be configured to: obtain input data having a number of bits according to a first precision and including one or more tokens; determine a second precision as a level of precision for input to a next computation operation of a neural network architecture; for each particular token of the one or more tokens of the input data: generate a token scale factor based on a range of values associated with the token; and execute a quantization operation on the token of the input data based upon using the token scale factor to update the token of the input data from the first precision to a quantized token having the second precision for the level of precision for the next computation operation; and generate output data by executing the next computation operation using each quantized token having the number of bits according to the second precision.

The processor may be further configured to: generate a channel scale factor for each channel of one or more channels of a tensor; and for each channel, apply the channel scale factor to the channel according to the second precision. The processor may be further configured to: for each channel of the one or more channels of the tensor: determine a maximum absolute value amongst a plurality of values of the input data in the channel; and determine the channel scale factor based upon a range of values using the maximum absolute value.

The processor is further configured to determine the level of precision based on at least one of: a signal-to-noise ratio of the input data, a loss function associated with a training process of the neural network architecture, or a computational constraint of a hardware accelerator. The processor may be further configured to extract the one or more tokens from the input data.

The processor may be further configured to: during a training phase of the neural network architecture: obtain training data having the first precision; execute the quantization operation on the training data according to the second precision; generate predicted output data of the next computation operation using the training data having the second precision; and update one or more parameters of the neural network architecture based on a loss value between the predicted output data and a training label.

The processor may be configured to execute the next computation operation using an accelerator including at least one of a MAC unit or a SIMD processor.

The processor may be further configured to: generate a plurality of data blocks from the input data based upon a tiling configuration of a tensor along one or more dimensions of the tensor, each data block of the input data includes a subset of values within the tensor defined along the one or more dimensions of the tensor; and for each data block of the plurality of data blocks, apply a block scale factor to the data block based upon a range of values amongst the subset of values of the data block according to the second precision.

The processor may be further configured to: for each data block of the plurality data blocks: determine a maximum absolute value amongst the subset of values of the input data in the data block; and determine the block scale factor based upon the range of values amongst the subset of values of the input data in the data block using the maximum absolute value of the data block.

The processor may be further configured to store each token scale factor into a non-transitory machine-readable storage.

The processor is further configured to: for each data block of the plurality data blocks: determine a maximum absolute value amongst the subset of values of the sensor data in the data block; and determine the block scale factor based upon the range of values amongst the subset of values of the sensor data in the data block using the maximum absolute value of the data block.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A is a non-limiting example of components of a system in which the methods and systems discussed herein can be implemented.

FIGS. 1B-1C illustrate block diagrams of sensors integrated within the egos, according to embodiments.

FIG. 2A shows a dataflow amongst components of a mixed-precision transformer portion of a machine-learning architecture, according to various embodiments.

FIG. 2B shows another dataflow amongst components of a mixed-precision transformer portion of a machine-learning architecture, according to embodiments.

FIG. 2C shows another dataflow amongst components of a mixed-precision transformer portion of a machine-learning architecture implementing Rotary Position Embedding (RoPE) layers, according to embodiments.

FIG. 2D shows another dataflow amongst components of a mixed-precision transformer portion of a machine-learning architecture implementing a feedforward network, according to embodiments.

FIG. 2E shows another dataflow amongst components of a mixed-precision transformer portion of a machine-learning architecture implementing a hybrid quantization approach, according to embodiments.

FIG. 3 is a dataflow amongst components of dynamic quantization layers of a mixed-precision transformer, according to embodiments.

FIG. 4 is a dataflow amongst components of portion of a mixed-precision transformer for performing convolution operations, according to embodiments.

FIG. 5 is a dataflow amongst components of portions of a mixed-precision transformer for performing convolution operations, according to embodiments.

FIG. 6 is a flowchart of a method for processing sensor data using a mixed-precision transformer of a machine-learning architecture, according to embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

The mixed-precision quantization framework is designed for transformer models of machine-learning architectures and optimized for accelerators, which may be equipped with MAC units (e.g., INT4 MAC, INT8 MAC, INT15 MAC, INT16 MAC) and SIMD processors (e.g., FP32 SIMD). The mixed-precision transformer architecture leverages high-throughput datatypes, enabling the efficient use of both integer and floating-point arithmetic. The input data undergoes several transformations and normalizations within the mixed-precision transformer. The input data may include types of tokenizable data that components of the machine-learning architecture, such as the transformer, may tokenize, extract, or otherwise parse into tokens and/or process as tokens of the input data. Embodiments described herein implement input sensor data, though embodiments are not so limited. The input data may include virtually all structured or unstructured data types and formats, including but not limited to sensor data, image data, audio signals, text, tabular data, and time-series data, among others. A normalization layer is responsible for performing normalization operations on the input sensor data, including RMSNorm, LayerNorm, and other normalization techniques.

One of the critical aspects of the mixed-precision transformer is the use of dynamic quantization. The dynamic quantization layers execute functions to vary the level of precision of the input sensor data. Tensors are dynamically quantized per token typically from a higher precision data type (e.g., BF15, BF16) to a lower precision data type (e.g., INT4, INT8, INT15, INT16). This approach allows for dynamic input ranges, making the machine-learning architecture to be robust to different permutations of input data. Although embodiments described herein mention the use of dynamic quantization functions to improve the performance of transformer models, embodiments are not so limited. The dynamic quantization functions described herein may be implemented in various types of machine-learning models and machine-learning architectures in order to increase or decrease the precision (e.g., number of bits) of data representing vectors or matrices (or other types of data) as needed to improve performance of the layers or functions of the various types of machine-learning models. As mentioned, the various features and functions described herein may be applicable to any data type or format of input data that can be tokenized, for various types of sources or modalities from which the input data may be received. This includes input data originated at or received from, for example, sensors, documents, or logs, among other types of digital sources.

The dynamic quantization function of the dynamic quantization layers involves generating unique scale factors for quantization independently along a specified axis within the input sequence. For a sequence length N and hidden dimension D, this means generating N unique scale factors, allowing precise control over the quantization process and balancing computational efficiency with accuracy.

The mixed-precision quantization framework offers several advantages, including reduced memory bandwidth requirements, improved energy efficiency, and accelerated inference times. These benefits contribute to the overall performance and adoption of the transformer-based models on specialized hardware platforms.

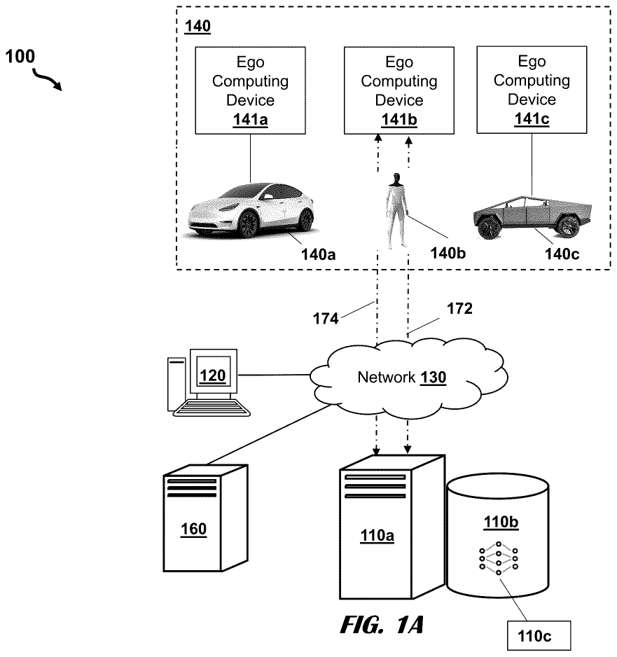

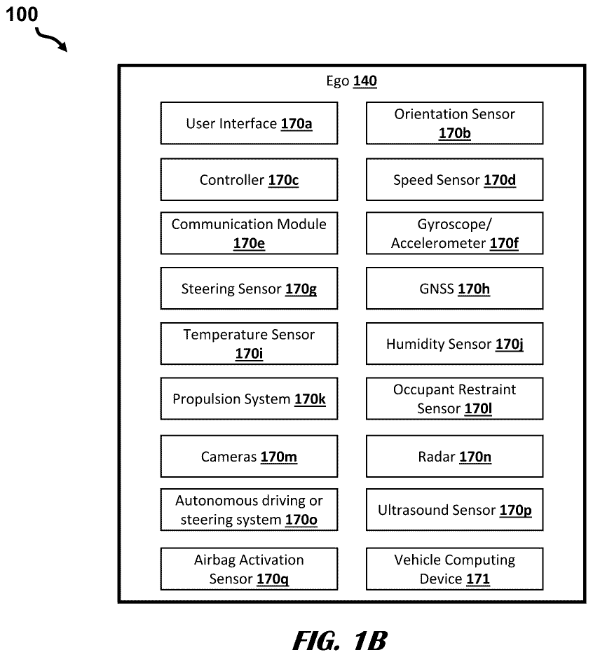

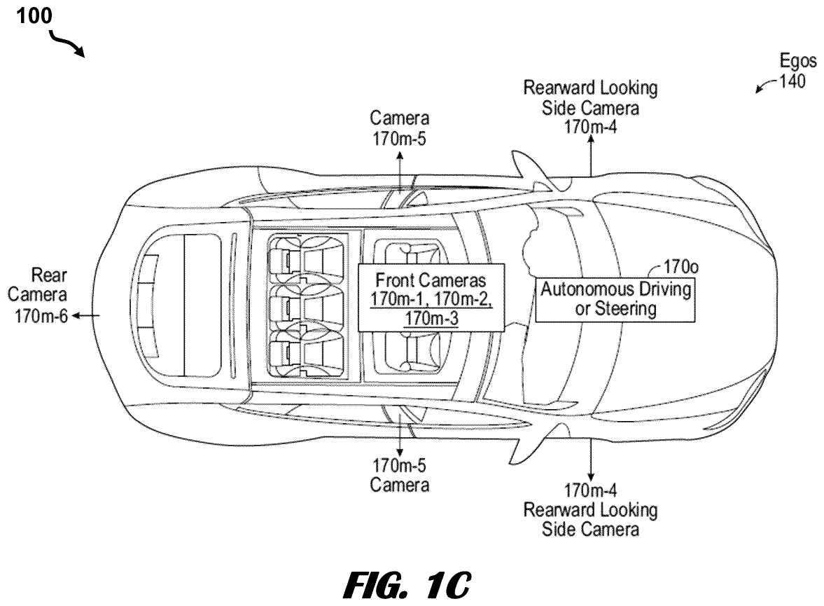

FIG. 1A is a non-limiting example of components of a system in which the methods and systems discussed herein can be implemented. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can execute the AI model(s) 110c using data retrieved from the egos 140 (e.g., by using data streams 172 and 176) to make navigational decisions. When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to the AI model(s) 110c at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate navigational decisions for the egos 140.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased, rented, leased, etc. by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict a navigational decision. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-1C illustrate block diagrams of sensors integrated within the egos 140, according to embodiments. The number and position of each sensor discussed with respect to FIGS. 1B-1C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 170o). Therefore, the user interface 170 a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140 and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras 170m-1. These cameras may monitor and collect footage of the occupants of the egos 140. The egos 140 may also include a forward-looking side camera 170m-2, a camera 170m-3 (e.g., integrated within the door frame), and a rearward-looking side camera 170m-4.

In some embodiments, the methods and systems discussed herein can operate exclusively with 2D sensors (e.g., 2D cameras) that may explicitly exclude depth cameras, time-of-flight (ToF) sensors, and other specialized depth-sensing technologies. The AI model and processing pipelines discussed herein can be trained to extract spatial and environmental information solely from monocular or stereo 2D image inputs without relying on depth estimation hardware. This ensures compatibility with 2D camera systems that only transmit captured images without any additional depth data, while maintaining robust performance in autonomous navigation and visual data analysis.

Referring to FIG. 1B, a radar 170n and ultrasound sensors 170p may be configured to monitor the distance of the egos 140 to other objects, such as other vehicles or immobile objects (e.g., trees or garage doors). The radar 170n and the ultrasound sensors 170p may be integrated into the egos 140 as depicted in FIG. 1C. The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-1C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict navigational decisions for the one or more egos 140.

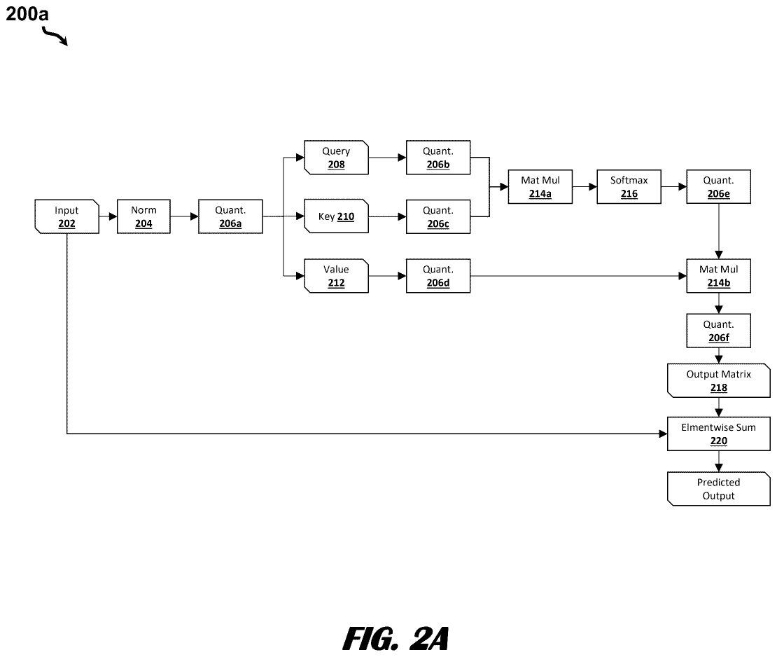

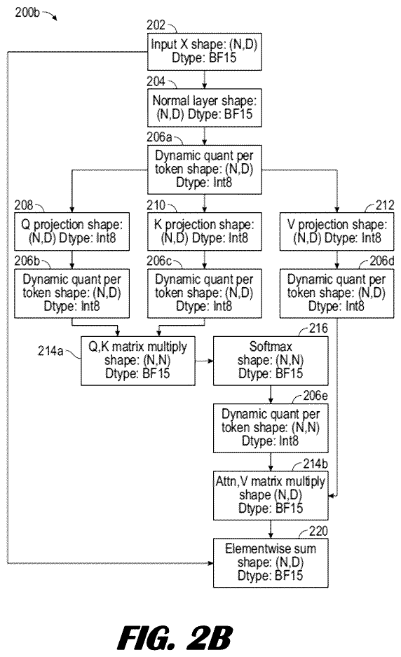

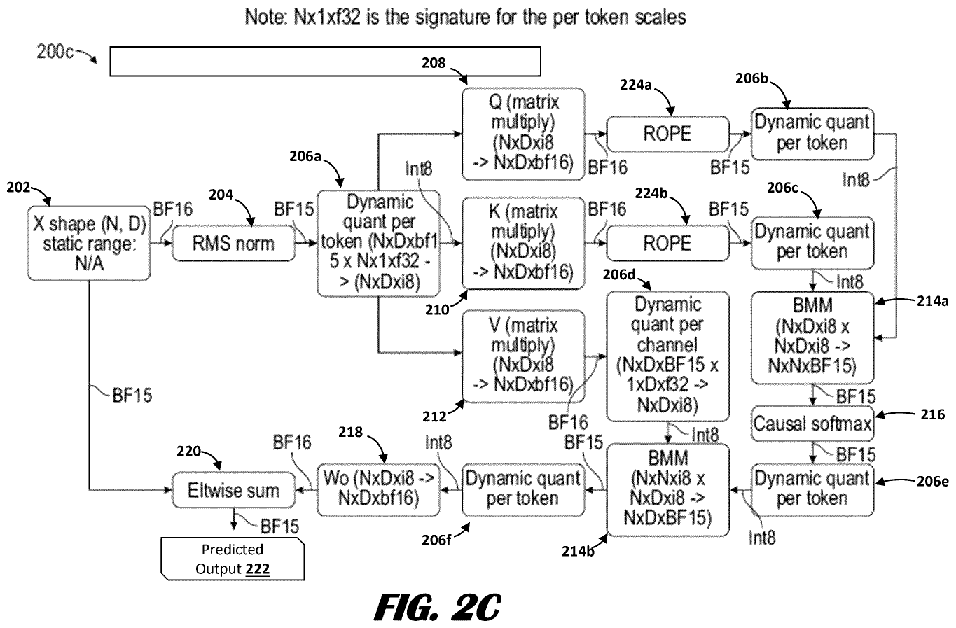

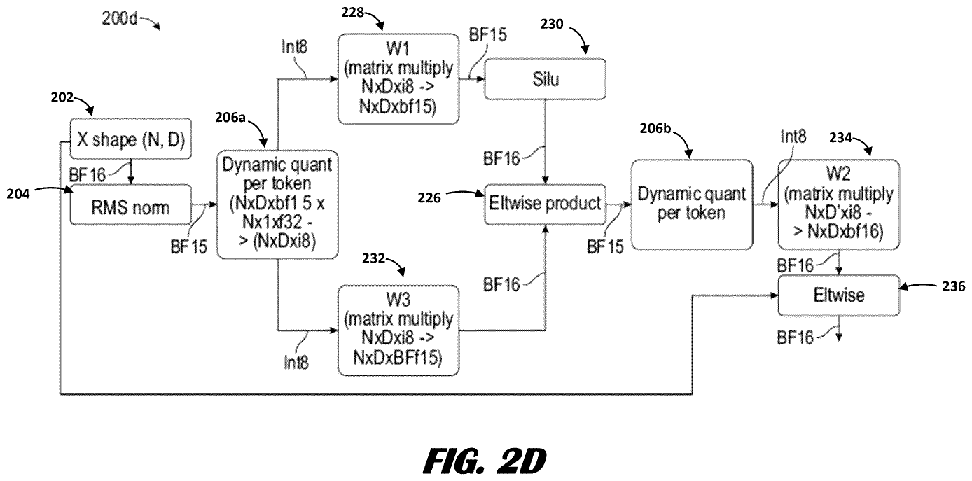

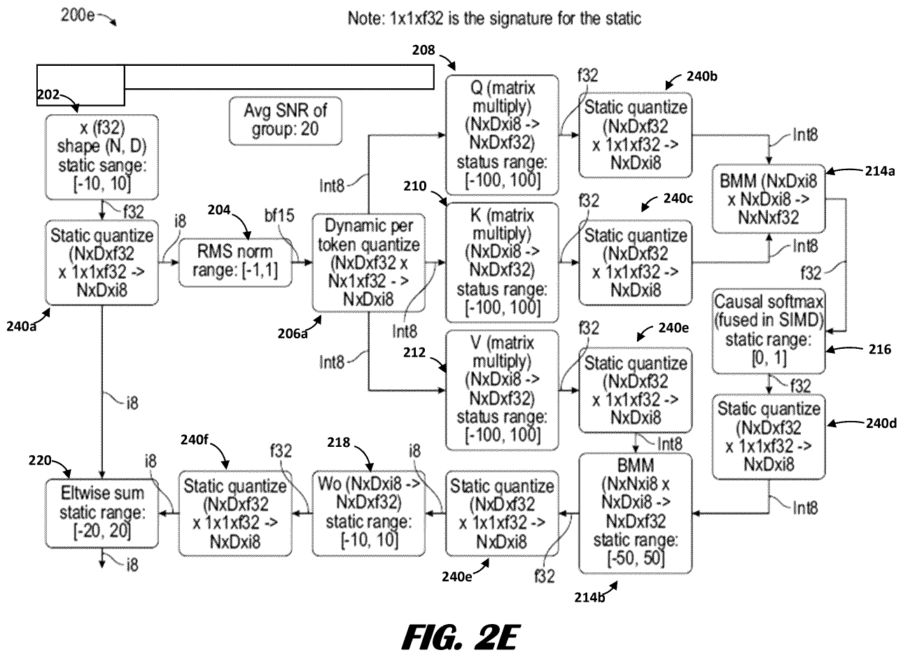

FIGS. 2A-2E are example dataflows amongst components of a mixed-precision transformer portion of variants of a machine-learning architectures 200a-200e (generally referred to as a machine-learning architecture 200).

FIG. 2A is an example dataflow amongst components of a mixed-precision transformer portion of a machine-learning architecture 200a, according to embodiments. The mixed-precision transformer 200a may be implemented by one or more processors of an automated device, such as an ego computing device (e.g., ego computing device 141), an analytics server (e.g., analytics server 110a), or other computing systems configured to execute machine-learning models. These processors may include, for example, INT8 MAC units and FP32 SIMD processors. The machine-learning architecture 200 includes a normalization layer 204 that receives input data 202, dynamic quantization layers 206a-206f (generally referred to as dynamic quantization layers 206), query vector projections (referred to as query projections 208), key vector projections (referred to as key projections 210), value vector projections (referred to as value projections 212), matrix multiplication layers 214a-214b (generally referred to as matrix multiplication layers 214), an output matrix 218, an elementwise sum layer 220, and the predicted output 222 of the transformer of the machine-learning architecture 200.

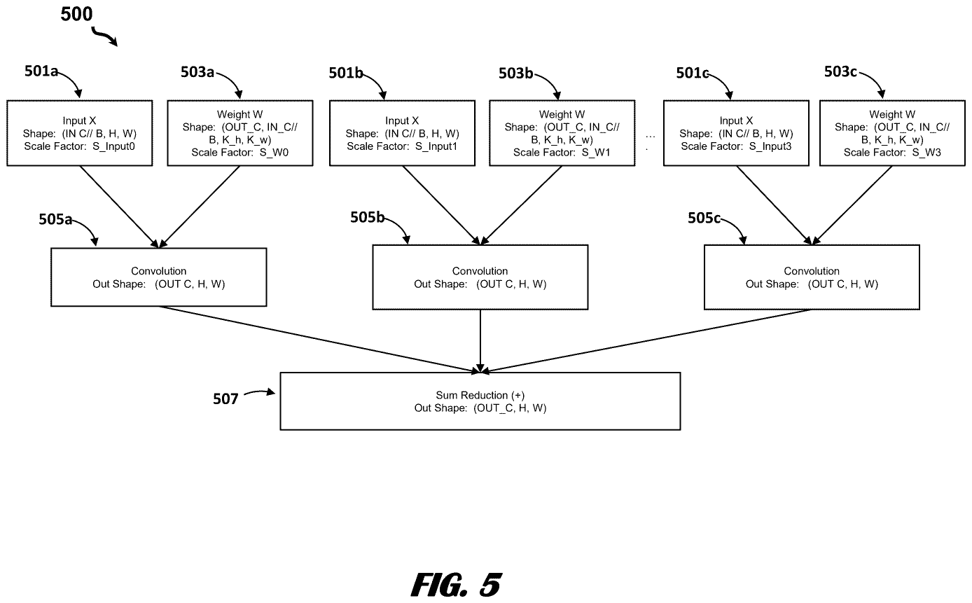

Dynamic quantization generally refers to calculating and implementing scale factors for quantization operations. The dynamic quantization operations of the dynamic quantization layers 206 may be performed “on the fly” and/or calculated offline. The dynamic quantization operations can be further broken down and performed at various different axes or levels of the tensor (per token, per channel, per block or segment), as in the operations of FIG. 5. The dynamic quantization operations can be performed according to various types of data types or data ranges (e.g. dynamic quantization per token to or from, for example, INT4, INT8, or INT16), though the embodiments depicted herein show dynamic quantization to INT8. For instance, each dynamic quantization layer 206 may compute a set of scale factors per token (e.g., one scale factor for each row of the input tensor of the input data 202) and store these scale factors in registers or other non-transitory machine-readable storage. The quantization layers 206 then apply the scale factors to convert the higher-precision tensors (e.g., BF15) to lower-precision tensors (e.g., INT8) for efficient processing.

The input sensor data 202 includes various types of sensor data or other inputs generated and used by an automated device, such as a robot or autonomous vehicle. Examples of sensor data for an autonomous vehicle include visual data from cameras, lidar data capturing distances and shapes of surrounding objects, radar data for detecting speed and movement of nearby entities, and ultrasonic data for close-range object detection.

The normalization layer 204 includes operations for ingesting and normalizing the input sensor data 202. The normalization layer 204 is responsible for performing normalization operations on the input sensor data 202, such as Root Mean Square Normalization (RMS Norm), Layer Normalization (LayerNorm), and other normalization techniques. The ingestion process into the transformer architecture includes normalization operations executed by the normalization layer 204, which standardizes the input sensor data 202 through techniques such as RMS Norm and LayerNorm. The input tensor of the input data 202 may be represented in a higher-precision format (e.g., BF15), and the normalization layer 204 may preserve this precision to maintain numerical stability.

Subsequently, dynamic quantization layers 206 adjust the precision of the data types from higher precision formats (e.g., BF15, BF16) to lower precision formats (e.g., INT8), optimizing the data for efficient processing. The transformer utilizes extraction layers (not shown) for parsing input elements or tokens from the input data 202, and generating query vectors 208, key vectors 210, and value vectors 212 that represent different aspects of each token or element. These vectors can undergo linear or other transformations to generate relevant projections used for attention operations, ultimately combining and weighting the value vectors to produce a comprehensive understanding of the input data input data 202. Generally, the dynamic quantization operations adjust from higher precision to lower precision, though embodiments are not so limiting. Moreover, the dynamic quantization operations may alter the number of bits for a particular precision or data type (e.g. INT15, INT8, INT4, etc.). In some embodiments, the dynamic quantization layers 206 may adjust the precision from a lower precision (e.g., fewer bits) or lower precision data format (e.g., INT8) to a higher precision (e.g., more bits) or higher precision format (e.g., BF15, BF16). Additionally or alternatively, in some embodiments, the dynamic quantization layers 206 may adjust the level of precision by reducing or increasing the number of bits, without affecting the data format.

The dynamic quantization layers 206 can execute dynamic quantization functions to update or change the data type and level of precision of data being handled by components of the machine-learning architecture 200. For instance, a first dynamic quantization layer 206a executes the dynamic quantization function on the input data 202 or tensors, to reduce the input data 202 or tensors from a higher precision data type (e.g., floating point BF15, BF16) to a lower precision data type (e.g., integer INT8).

The transformer of the machine-learning architecture 200 includes layers or functions for extracting vectors for performing attention functions. In operation, an extraction layer (not shown) parses or extracts input elements or (tokens) of the input data 202 and generates or projects these tokens into query vectors 208 of query projections, key vectors 210 of key projections, and value vectors 212 of value projections, in the form of sperate matrices of the respective vectors.

Each token in a sequence of the input data 202 starts with an embedding vector that encapsulates a general meaning. The transformer may learn to extract specific aspects of this meaning by applying three separate linear transformations using linear transformation functions, to generate the query vector 208, key vector 210, and value vectors 212.

A query vector 208 of the query projection represents an aspect of a token that will be used to “search” for relevant context. The query vector 208 represents a current element (or token) for which the transformer model is trying to determine which parts of the input data 202 are most relevant when performing the transformer's search function. In some cases, the generates the query vector 208 by projecting the input data 202 using a learned linear transformation.

A key vector 210 of the key projections represents the features against which the query vector 208 is compared. Each token from the input data 202 is associated with a key vector 210, which serves as an identifier or a reference for performing the transformer's search function. When performing the search function using a query vector 208, the query vector 208 is compared against each key vector 210 to determine query similarity scores, which indicate how much focus should be placed on each corresponding token represented by the particular key vector 210.

A key vector 210 represents or contains the content or information that will be combined, weighted by one or more values or scores. The value vectors 210 represent the “actual” information (e.g., sensor data) of the tokens that will be aggregated. After computing the query similarity scores between the query vector 208 and each key vector 210, the transformer model uses the query similarity scores to create a weighted sum of the value vectors 210. This sum represents the attended information relevant to the query.

The attention operations of the transformer 200 can receive the input data 202 in a lower precision data format (e.g., INT8), and may then extract or generate the various projections in a higher precision format (e.g., BF15). As such, the transformer 200 may feed the projections into one or more dynamic quantization layers 206 to reduce the projections to a lower precision data format (e.g., INT8). In some cases, the matrix multiplication layers 214 may transform the INT8 inputs to BF15 or FP32 for higher-precision.

The matrix multiplication layers 214 within the transformer processes query vectors 208, key vectors 210, and value vectors 212 derived from input data 202. Linear transformations applied to input elements parsed from the input data 202 generate these vectors, encapsulating aspects of each token. In some cases, the matrix multiplication layer 214a combines these vectors through operations that compute similarity scores between query vectors 208 and key vectors 210. In some cases, these scores determine a weighted sum of corresponding value vectors 212, that a matrix multiplication layer 214b uses when producing attended information that represents the input data 202 in a transformed format.

In some embodiments, the machine-learning architecture 200 may implement offline per-channel quantization of weights for a training process or tuning purposes, in which parameters or weights of a neural network or other components of the machine-learning architecture 200. The dynamic quantization operations may be performed offline, where the dynamic quantization operations are performed after the training phase and do not require any modifications to the training process itself. In offline per-channel quantization, the machine-learning architecture 200 implements the dynamic quantization layers 206 (or static quantization functions) to quantize the weights of a model, during or after the training process of the initial training phase. In some cases, the training process or tuning process may use pre-trained knowledge embedded in the model parameters such that the quantization operations do not significantly degrade the model's performance. The quantization is done on a per-channel basis, meaning that each channel of the weight tensor is quantized independently. During the training process of the training phase, weights or parameters may be dynamically quantized per channel so that the precision is adjusted based on the specific requirements of each channel. The dynamic quantization layers 206 among other components of the machine-learning architecture 200 may be trained on various levels of precision, such as INT8, FP32, and FP16, among others. The dynamic quantization layers 206 may be trained using weights that are quantized to the lower precision data type, such as INT8. This quantization process involves mapping the high-precision weights to a lower precision representation. In particular, the dynamic quantization layers 206 may be trained to calculate scale factors for each channel (e.g., “channel scale factor”), which are used to dynamically quantize the weights or perform other functions. The dynamic quantization operations may be tailored to a preconfigured or pretrained range of values in each channel, or dynamically determined range of values in each channel.

Optionally, the dynamic quantization process may emulate during training to mimic “real world” conditions that the machine-learning architecture 200 will encounter during inference time.

The machine-learning architecture 200 may include an optional loss layer (not shown) or loss function that adjusts parameters of the dynamic quantization layers 206 or other components of the machine-learning architecture 200. The loss value may be computed between the predicted output and a corresponding training label, such as a ground truth classification or regression target. These adjusted parameters of a neural network or other components of the machine-learning architecture 200 cause the dynamic quantization layers 206 to determine different levels of precision based on the loss function and other metrics during the training process of the training phase. This allows for targeted precision adjustments, such that critical parts of the machine-learning architecture 200 use higher precision inputs and less critical parts of the machine-learning architecture 200 can use lower precision inputs. In some embodiments, the transformer of the machine-learning architecture 200a may be trained using quantized data to emulate inference-time conditions. During the training process of the training phase, the machine-learning architecture 200 may obtain training data represented in a first precision format (e.g., FP32 or BF16) and apply a quantization operation using dynamic quantization layers 206 to convert the training data to a second, lower precision format (e.g., INT8). The quantized training data is then processed through the layers of the transformer, including the matrix multiplication layers 214 and attention mechanisms, to generate predicted output data. The optional loss function may compare the predicted output data to a corresponding training label, such as a ground truth classification or regression target. Based on the computed loss value, the loss function or back-propagation function updates one or more parameters of the neural network of the transformer model, including weights associated with the projection layers 208, 210, 212 and the dynamic quantization layers 206.

In some cases, prior to the matrix multiplication operation of the matrix multiplication layers 214, the dynamic quantization layers 206 converts the inputs into lower precision formats, such as INT8, then reverting it to higher precision formats, such as BF15, for downstream operations. The transformer integrates dynamic quantization layers 206 to adjust data precision dynamically, optimizing computational efficiency. Each input token starts with an embedding vector, which undergoes transformations to produce relevant projections used in attention operations.

The softmax layer 216 is implemented to convert the aggregated information from certain vectors into a probability distribution. The softmax layer 212, for example, takes the weighted sum of the input vectors and applies an exponential function, followed by normalization, to generate a set of probabilities that sum to one. These probabilities represent the attention weights assigned to each token, reflecting the importance of each token in the context of the input data 202. The softmax operation enables the transformer to focus on relevant tokens by emphasizing those with higher attention weights, thus facilitating effective information retrieval and representation for further processing stages.

An output matrix 218 (sometimes denoted ‘W0’) resulting from a matrix multiplication layer 214b encapsulates the weighted sum of value vectors 212 and combined query vector 208 and key vector 210 derived from the input data 202. This matrix 218 operates as a representation of the attended information, transformed through a series of linear transformations and attention mechanisms. Each entry in the matrix 218 corresponds to a combination of input elements, reflecting the relevance and context established by the attention functions. The resulting weights in the output matrix indicate the significance of each token within the given sequence, as determined by the similarity scores between the query and key vectors.

The elementwise sum operation 220 in the transformer aggregates corresponding elements as aggregated in the output matrix 218 to produce a single combined vector. This operation 220 involves summing the individual elements of vectors on a per-element basis. For instance, if two vectors have the same dimension, the sum operation will add each element of the first vector to the corresponding element of the second vector, resulting in a new vector of the same dimension. This combined vector integrates information from the input elements, retaining the individual contributions of each vector while producing a new vector that encapsulates the aggregated data. The elementwise sum operation 220 represents a function of synthesizing information across different layers and projections, enabling the transformer to maintain a coherent and comprehensive representation of the input data 202.

FIG. 2B is another example dataflow amongst components of a mixed-precision transformer portion of a machine-learning architecture 200b, according to embodiments. The mixed-precision transformer 200b may be implemented by one or more processors of an automated device, such as an ego computing device (e.g., ego computing device 141), an analytics server (e.g., analytics server 110a), or other computing systems configured to execute machine-learning models. These processors may include, for example, MAC units and SIMD processors. The machine-learning architecture 200b is generally the same as the machine-learning architecture 200a, where FIG. 2B depicts example parameters, dimensions, and data types of the data implemented at each of the various layers or operations.

The machine-learning architecture 200b uses high throughput datatypes which leverages the INT8 MAC for data-loading. This allows important operations such as normalization operations (RMSNorm, LayerNorm) of normalization layers 204 and the residual stream to operate entirely on high-precision data. The input tensors of the input data 202 may be represented in BF15 format and normalized using normalization layer 204 before being quantized. Enabling a high-precision residual stream improves mixed precision transformer performance.

In addition to the high precision operations, FIG. 2B marks the areas in which tensors (e.g., query vectors 208, key vectors 210, value vectors 212) are dynamically quantized per token by the dynamic quantization layers 206 to INT8. Each dynamic quantization layer 206 may compute a unique scale factor for each token (e.g., each row of the tensor), resulting in N scale factors for a sequence length N. These scale factors may be stored in registers or other non-transitory machine-readable storage and applied to convert BF15 tensors to INT8 format. For per token quantization, the dynamic quantization layers 206 may specify an axis along which scale factors for quantization are generated independently.

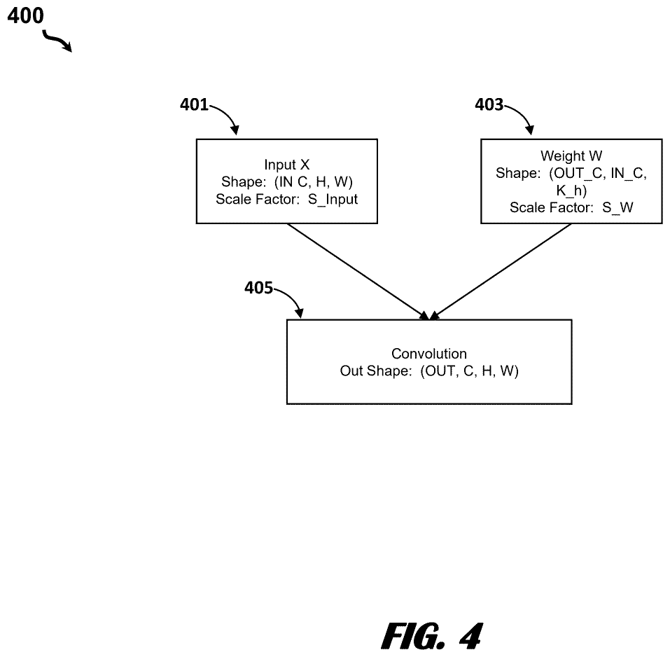

In the transformer component of the machine-learning architecture 200b, for a sequence length N and hidden dimension D, this means the dynamic quantization layers 206 generate N unique scale factors. While the dynamic quantization still is a primary source of any model accuracy degradations, the degradation can be alleviated. In some cases, dense compute operations can be tiled based on the MAC unit shape. This allows the machine-learning architecture 200b to introduce more quantization scale factors by splitting or tiling operations along both the input spatial dimension (Height, Width) and the output channel dimension. For example, for a tile of output size M×N with reduction dimension K, if the output dimension M<<D, this means the machine-learning architecture 200b generates N scales for every M element, rather than for every D. In some cases, dense operations can also be split along the “inner” dimension, via computing a sum of elementwise outer products, as in FIGS. 4-5.

Since the high-throughput datatypes allow for fully, high precision sums, an arbitrary number of scale factors can be introduced to the compute operation, enabling the transformer to preserve more information in regions of the tensor that would otherwise be compressed or saturated under global quantization. This is because the machine-learning architecture 200b can split along spatial dimension N, outer dimension M, and inner dimension K, at any arbitrary granularity, albeit at a performance tradeoff.

FIG. 2C is another example dataflow amongst components of a mixed-precision transformer portion of a machine-learning architecture 200c implementing Rotary Position Embedding (RoPE), according to embodiments. The mixed-precision transformer 200c may be implemented by one or more processors of an automated device, such as an ego computing device (e.g., ego computing device 141), an analytics server (e.g., analytics server 110a), or other computing systems configured to execute machine-learning models. These processors may include, for example, INT8 MAC units and SIMD processors. The machine-learning architecture 200c is generally the same as the earlier described machine-learning architecture 200a, where FIG. 2C depicts example parameters, dimensions, and data types of the data implemented at each of the various layers or operations. For instance, the machine-learning architecture 200c includes an input tensor 202 of input sensor data, a normalization layer 204, dynamic quantization layers 206a-206f(generally referred to as dynamic quantization layers 206), query vector 208 (or query projection 208), key vector 210 (or key projection 210), value vector 212 (or value projection 212), RoPE layers 224a-224b (generally referred to as RoPE layers 224), matrix multiplication layers 214a-214b (generally referred to as matrix multiplication layers 214), softmax layer 216, output matrix 218, a sum layer 220, and a predicted output 222.

The input tensor 202 represents the input data entering the transformer of the machine-learning architecture 200c. As shown in FIG. 2C, the input sensor 202, labeled “X” includes an annotation “Shape: (N, D)” and “BF16,” indicating that the tensor 202 includes N tokens, each with D features, and is represented in bfloat16 (BF16) format.

The input tensor 202 is processed by normalization layer 204, which performs normalization operations, such as RMSNorm or LayerNorm, to standardize the input distribution and converts the input tensor 202 from a received input data format (e.g., BF16) to another data format (e.g., BF15). For example, the normalization layer 204 performs an RMSNorm, indicating that Root Mean Square Normalization operation, is applied to the input tensor 202 before quantization.

The now-normalized tensor is then fed to a dynamic quantization layer 206a that performs a quantization operation. To quantize the normalized input tensor data, the quantization operation of the first dynamic quantization layer 206a, for example, computes per-token scale factors and converts or transforms the normalized BF15 tensor to a lower-precision data format (e.g., INT8 format). Each per-token scale factor (or token scale factor) may be computed for each token independently and applied during quantization operations. For instance, the dynamic quantization layer 206a applies per-token quantization operations to the normalized input tensor. As shown in FIG. 2C, the first dynamic quantization layer 206a includes “NxDxbf15×Nx1xf32 →NxDxi8,” which indicates that each token (row) of the normalized tensor (BF15) input is scaled by a corresponding per-token scale factor (Nx1xf32) and quantized to another (INT8) format.

The quantized tensor is passed to the query projection 208 operations, key projection 210 operations, and value projection 212 operations, which perform various operations that transform or project the quantized sensor into a query vector (Q), a key vector (K), and a value vector (V). The operations of the query projection 208 transform the quantized input into the query vector. As seen in FIG. 2C, the query projection 208 depicts “Q (Matrix Multiply NxDxi8→NxDxbf15),” indicating that the INT8 input to the query projection 208 is multiplied by a weight matrix to produce a BF15 output. The operations of the key projection 210 transform the quantized input into a key vector. As seen in FIG. 2C, the key project 210 depicts “K (Matrix Multiply NxDxi8→NxDxbf15),” indicating that that the INT8 input to the key projection 210 is multiplied by a weight matrix to produce a BF15 output. The operations of the value projection 212 transform the quantized input into a value vector. As seen in FIG. 2C, the value projection 212 depicts “V (Matrix Multiply NxDxi8→NxDxbf15),” indicating that that the INT8 input to the key projection 210 is multiplied by a weight matrix to produce a BF15 output.

The query projection 208 and the key projection pass the query vector and the key vector to RoPE layers that perform RoPE functions, where query vector is passed through a RoPE layer 224a, and the key vector is passed through another RoPE layer 224b. The RoPE function of the RoPE layers 224 is a flexible mechanism for handling positional information in transformer models. Unlike fixed or learned positional encodings, RoPE layers 224 employ a rotation-based method to encode positions, enabling a more nuanced representation of positional information. The RoPE functions rotate vectors in a high-dimensional space, where the RoPE layers 224 may apply a rotation matrix to the corresponding input embeddings, with the angle of rotation corresponding to the position in the sequence. This rotation operation is designed to preserve the relative distances between positions.

The RoPE function of the RoPE layers 224 applies the rotation-based transformation to the query vector and the key vector to encode the positional information in a higher-precision format (e.g., BF15 or BF16). The RoPE layers 224 rotate the input embeddings based upon the vector positions, before being fed into the self-attention mechanisms (e.g., matrix multiplication layer 214a). The resulting embeddings retain positional information in a way that enhances the transformer's ability to process sequence data. After the RoPE transformation, the resulting vectors may be dynamically quantized by dynamic quantization layers 206b-206c to INT8 format for efficient processing on INT8 MAC units. Each token may be associated with a unique scale factor, computed and stored in registers, to enable per-token quantization.

The transformer of the machine-learning architecture 200c executes the RoPE layers 224 to the respective vectors in a higher-precision data format, before applying the dynamic quantization layers 206 to reduce the level of precision. This combination of high-precision RoPE and low-precision quantized attention enables the transformer to maintain positional accuracy while benefiting from the efficiency of mixed-precision computation.

The matrix multiplication layer 214a computes attention scores by multiplying the matrices of the query vector and key vector. In FIG. 2C, the matrix multiplication layer 214a depicts an operation of “BMM (NxDxi8×NxDxi8→NxNxBF15),” where BMM stands for “batched matrix multiplication” using the quantized outputs of the RoPE layers 224a-224b and dynamic quantization layers 206b-206b. The result is a BF15 matrix of attention scores.

The softmax layer 216 processes the attention scores generated by matrix multiplication layer 214a. This softmax layer 216 converts the raw attention logits into a normalized probability distribution, enabling the transformer to assign relative importance to each token in the sequence. In FIG. 2C, the softmax layer 216 is annotated as “Causal Softmax,” indicating that the softmax operation is applied according to a causal (i.e., autoregressive) operation, such that each token's attention is restricted to preceding tokens, preserving the autoregressive property required for certain transformer applications (e.g., language modeling, sequential prediction).

The value projection 212 outputs the value vector to a dynamic quantization layer 206d. The dynamic quantization layer 206d performs per-token quantization operation on the value projection 212. This layer receives the value vector in BF15 format and applies a scale factor specific to each token to convert the data into INT8 format. In FIG. 2C, the dynamic quantization layer 206d is annotated “Dynamic Quant Per Token” and annotated with “BF15,” indicating that the input to this layer is in bfloat16 precision. The dynamic quantization layer 206d is further annotated “Dynamic Quant Per Token (NxDxbf15×Nx1xf32→NxDxi8),” which indicates that each token (row) of the BF15 input is scaled by a corresponding per-token scale factor (Nx1xf32) and quantized to INT8 format. The per-token quantization enables the transformer to adaptively compress the value vectors while preserving numerical fidelity across varying input distributions. This operation is essential for enabling efficient matrix multiplication in subsequent layers, particularly when executed on INT8 MAC hardware.

The matrix multiplication layer 214b performs a core attention operation by computing the weighted sum of the value vectors using the attention scores, where the matrix multiplication layer 214b computes the weighted sum of value vectors using the attention scores. The matrix multiplication layer 214b receives INT8 inputs, including the quantized attention weights from dynamic quantization layer 206e and the quantized value vectors from the dynamic quantization layer 206d. The operation is executed as a batched matrix multiplication, producing an output tensor in BF15 format. In FIG. 2C, the matrix multiplication layer 214b is annotated “BMM (NxNxi8×NxDxi8→NxDxBF15),” where BMM stands for the batched matrix multiplication operation, and the annotation indicates that the input matrices, one of shape (N, N) and the other of shape (N, D), are multiplied to generate an output of shape (N, D), with the result computed in bfloat16 precision. In this way, the matrix multiplication layer 214b aggregates contextual information across tokens in the sequence.

The dynamic quantization layer 206f receives the output of matrix multiplication layer 214b and performs per-token quantization to convert the BF15 output into INT8 format. The dynamic quantization operation of the dynamic quantization layer 206f shortens or compresses the attention output of the matrix multiplication layer 214b from, for example, BF15 to INT8 format. The dynamic quantization layer 206f may perform the operations similar to the other dynamic quantization layers 206, such as “Dynamic Quant Per Token (NxDxbf15×Nx1xf32→NxDxi8), where the quantization is performed per token, using a unique scale factor for each token (row), and these scale factors are stored in registers for efficient access during runtime.

The output matrix 218 represents the result of the quantized attention mechanism after the matrix multiplication results in matrix multiplication layer 214b (e.g., attention matrix multiplied by value matrix) and subsequent quantization by the dynamic quantization layer 206f. The output matrix 218 serves as the transformed representation of the input sequence of the input data 202, capturing contextual relationships between tokens. In FIG. 2C, the output matrix 218 is labeled “Wo (NxDxi8→NxDxbf16),” which indicates that the INT8 tensor produced by dynamic quantization layer 206f is projected back into BF16 format. This projection operation may be performed using a learned weight matrix to restore higher-precision representation for downstream operations.

The elementwise sum layer 220 performs a residual addition between the output of the attention mechanism and the original input or residual stream. This operation may be an architectural feature of transformer models, such as the transformer of the machine-learning architecture 200c, designed to preserve the original input signal of the input data 202 while integrating the contextualized representation produced by the attention block.

FIG. 2D is another example dataflow amongst components of a mixed-precision transformer portion of a machine-learning architecture 200d, according to embodiments. The machine-learning architecture 200d is generally the same as the earlier described machine-learning architectures 200a-200b, where FIG. 2D depicts example parameters, dimensions, and data types of the data implemented at each of the various layers or operations. The machine-learning architecture 200d implements the dynamically quantized attention in a feedforward network. The mixed-precision transformer of the machine-learning architecture 200d may be implemented by one or more processors of an automated device, such as an ego computing device (e.g., ego computing device 141), an analytics server (e.g., analytics server 110a), or other computing systems configured to execute machine-learning models. These processors may include INT8 MAC units and SIMD processors. The architecture of FIG. 2D shares several structural similarities with the architecture of FIGS. 2A-2C, including the use of an input tensor 202, a normalization layer 204, and dynamic quantization layers 206. The machine-learning architecture 200d of FIG. 2D depicts a feedforward network that follows the attention layer in a transformer architecture. This feedforward network includes additional matrix multiplication layers 228, 232, 234, nonlinear activation layer 23b0, and elementwise operation layers 226, 236.

The input tensor 202, labeled “X” in FIG. 2D, has shape (N, D) and is represented in BF16 format. This tensor is first processed by normalization layer 204, which applies RMSNorm to standardize the input distribution. The normalized tensor is then quantized by dynamic quantization layer 206a, which performs per-token quantization using scale factors stored in registers or other non-transitory machine-readable storage.

The quantized tensor is passed to a first matrix multiplication layer 228, labeled “W₁ (Matrix Multiply NxDxi8→NxDxbf15),” and a second matrix multiplication layer 232, labeled “W₃ (Matrix Multiply NxDxi8→NxDxBF15).” Each of these matrix multiplication layers 228, 232 performs a linear transformation on the INT8 input, projecting it into BF15 format. The first matrix multiplication layer 228 applies a learned weight matrix W₁ to transform the quantized tensor input into a data representation configured for a nonlinear activation function of the activation layer 230. The activation layer 230 performs the activation function, such as a Sigmoid Linear Unit (SiLU) function, on the inputted data representation, in BF15 format, of the quantized input tensor from the first matrix multiplication layer 228. In parallel, the second matrix multiplication layer 232 applies a different learned weight matrix W₃ to produce a complementary data representation of the same quantized input tensor, also in BF15 format.

The outputs of SiLU activation layer 230 and the second matrix multiplication layer 232 are then passed to an elementwise product layer 226, labeled “Eltwise product.” The elementwise operation layers 226 performs a token-wise multiplication of the two inputted BF15 tensors. This multiplicative interaction allows a neural network to modulate the activated features from W₁ with the complementary features from W₃.

The result of the elementwise product layer 226 is passed to a third matrix multiplication layer 234, labeled “W₂ (Matrix Multiply NxD′xi8→NxDxbf16),” which transforms and projects the intermediate representation from into BF16 format. This transformation prepares the data for integration with one or more downstream layers or operations.

The output of matrix multiplication layer 234 is passed to elementwise addition layer 236, labeled “Eltwise,” which performs a residual addition function in BF16 precision. This operation integrates the transformed representations and prepares a predicted output for subsequent layers of the transformer or other downstream component of the machine-learning architecture 200d.

FIG. 2E is another example dataflow amongst components of a mixed-precision transformer portion of a machine-learning architecture 200e, according to embodiments. The mixed-precision transformer of the machine-learning architecture 200e may be implemented by one or more processors of an automated device, such as an ego computing device (e.g., ego computing device 141), an analytics server (e.g., analytics server 110a), or other computing systems configured to execute machine-learning models. These processors may include INT8 MAC units and SIMD processors. The machine-learning architecture 200e is generally the same as the earlier described machine-learning architecture 200e, where FIG. 2E depicts example parameters, dimensions, and data types of the data implemented at each of the various layers or operations.

The machine-learning architecture 200e implements hybrid quantization that includes dynamic and static quantization, performed by static quantization layers 240a-240f (generally referred to as static quantization layers 240) and dynamic quantization layers 206. The dynamic quantization layers 206 may be programmed or trained for a particular Signal-to-Noise Ratio (SNR) value. For instance, FIG. 2E includes an annotation “Avg SNR of group: 20,” which refers to the average SNR achieved by the quantized representation of a group of tokens or activations intended for dynamic per-token quantization operations of the dynamic quantization layers 206. The static quantization layers 240 may apply a fixed-range quantization to a specific tensor or other type of input. In this way, the machine-learning architecture 200e is more likely to, for example, detect certain objects or conditions in a roadway, such as a redlight, and generate operation instructions for the automated device, such as stopping at the redlight.

The static quantization layers 240 may be used when the input distribution is known or stable, allowing for simplified and efficient quantization without runtime computation of scale factors, as required by the dynamic quantization layers 206. For example, certain static quantization layers 240b-240e may quantize the query vector, key vector, and value vector, as outputted from the tensor projection operations 208, 210, 212, and the certain other static quantization layers 240d-240f may quantize the attention weights, outputted projections, and a residual sum, respectively.

The input tensor 202, labeled “X (f32),” has shape (N, D) and is represented in FP32 format. The input tensor 202 is annotated with a “static range [−10, 10],” indicating that the values of the tensor within the given range (10 and −10). The input tensor 202 is passed to a static quantization layer 240a, which applies a fixed-range quantization operation to convert the FP32 tensor to INT8 format. Each static quantization layers 240, including static quantization layer 240a, performs These layers are labeled “Static Quantize (NxDxf32×1x1xf32→NxDxi8)” and transforms the input tensor 202 to an INT8 value (or other format) using a predetermined scale factor. In some cases, the scale factor is derived from the known static range of the input tensor 202, such as the static range of [−10, 10]. In some cases, values of the input data 202 that are outside the static range are clipped to fit within the INT8 range.

The quantized input tensor is then passed to a normalization layer 204, which performs a normalization operation, such as Root Mean Square Normalization (RMSNorm) or Layer Normalization (LayerNorm). The normalization layer 204 standardizes the input distribution to for a range, such as [−1, 1] in FIG. 2E.

The normalized tensor is then passed to the dynamic quantization layer 206a, which performs per-token quantization using scale factors computed at runtime. Each token (e.g., each row of the input tensor 202) is associated with a unique scale factor, which is used to transform the floating-point values to INT8 format. The dynamic quantization layer 206a computes the quantization parameters, such as the scale factor (Nx1xf32), are chosen such that the resulting INT8 representation of each token achieves the given average SNR.

The quantized and normalized tensor is then passed to query projection layer 208, key projection layer 210, and value projection layer 212 to perform matrix multiplication operations and output the corresponding query vector, key vector, and value vector. Each of these layers 208, 210, 212 performs a matrix multiplication operation using INT8 inputs and produces outputs in FP32 format. These layers 208, 210, 212 are annotated with “static range” values (e.g., [−100, 100]), which indicate the ranges of the resulting vectors. These annotations are used to inform subsequent static quantization layers 240b, 240c, 240e, which convert the outputs of the Q, K, and V projection layers 208, 210, 212 back to INT8 format using fixed quantization parameters.

The quantized query and key vectors (Q, K) are passed to matrix multiplication layer 214a, which performs a BMM operation to compute attention scores. The output of matrix multiplication layer 214a is passed to softmax layer 216, which applies a causal softmax operation to normalize the attention scores. The normalized scores are quantized by static quantization layer 240d and passed to matrix multiplication layer 214b. The value vector (V) is quantized by the static quantization layers 240e and also passed to the matrix multiplication layer 214b. The matrix multiplication layer 214b performs a second BMM operation using the quantized attention scores and the quantized value vector, from the preceding static quantization layers 240d, 240e.

The output of matrix multiplication layer 214b is passed to output matrix 218, labeled “Wo (NxDxi8→NxDxf32),” which projects the INT8 tensor back into FP32 format. The result is then quantized by static quantization layer 240f and passed to elementwise sum layer 220, which performs a residual addition operation to integrate the attention output with the quantized input tensor from the static quantization layer 240a or residual stream. The elementwise sum operation is annotated with a “static range [−20, 20],” indicating that the range of the output values produced by the elementwise sum layer 220.

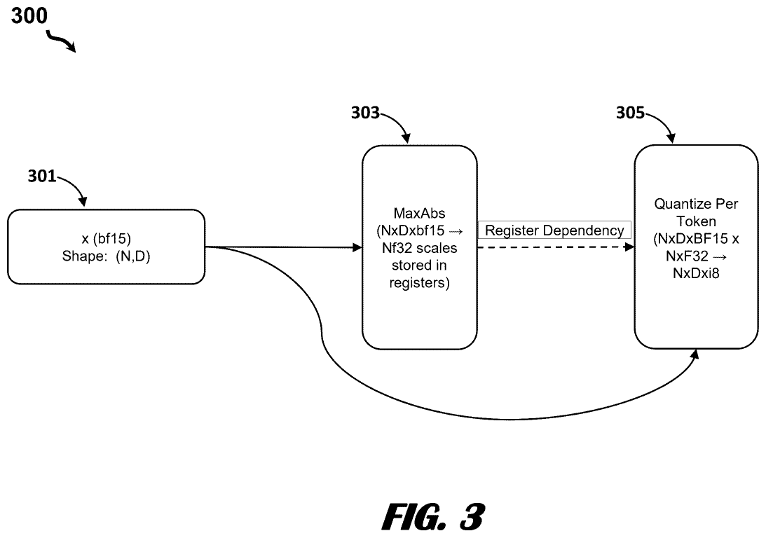

FIG. 3 is an example dataflow amongst components of dynamic quantization layers of a mixed-precision transformer of a machine-learning architecture 300, according to embodiments. The machine-learning architecture 300 may be implemented by one or more processors of an automated device, such as an ego computing device (e.g., ego computing device 141), an analytics server (e.g., analytics server 110a), or other computing systems configured to execute machine-learning models. These processors may include INT8 MAC units and SIMD processors, though embodiments are not so limited and may include, for example, INT4 MAC units, INT8 MAC units, INT15 MAC units, and INT16 MAC units, among others. The dynamic quantization layer 300 is designed to convert high-precision input tensors into lower-precision representations (e.g., INT4, INT8, INT 15, INT16) using per-token scale factors computed at runtime. The machine-learning architecture 300 includes an input tensor 301 or vector, an absolute maximum layer 303, non-transitory machine-readable storage (e.g., registers), and a quantization layer 305. The dynamic quantization layers adjust the precision of data on-the-fly based on the range of values in the input tensor 301.

The input tensor 301, labeled “Input X,” has shape (N, D) and is represented in BF15 format. This tensor may represent a sequence of N tokens, each with D features. The input tensor 301 is passed to a maximum absolute value (“MaxAbs”) operation 303, which computes the maximum absolute value for each token (i.e., each row of the tensor 301). This operation 303 produces a vector of N scale factors, which are stored in registers or other non-transitory machine-readable storage. These scale factors are used to normalize the input tensor 301 on a per-token basis.

In some implementations, a static quantization layer (not shown) uses a fixed range on the input tensor 301 that was previously determined during calibration, which may not be optimal for all scenarios. For example, a range calibrated for daylight conditions may not be suitable for low-light conditions, leading to inefficient use of bit width. The dynamic quantization layer of the machine-learning architecture 300 adjusts the range in real-time based on the values of the current input tensor 301. In this way, the dynamic quantization layers are optimized for the current data, improving precision and reducing information loss.

The absolute maximum layer 303 determines the maximum absolute value in the input tensor 301. The absolute maximum layer 303 identifies the maximum absolute value by iterating through each element of the input tensor 301 and comparing the absolute value against a current maximum absolute value. When the absolute maximum layer 303 identifies the maximum absolute value in the input tensor 301, the absolute maximum layer 303 dynamically adjusts the range to fit the current data of the input tensor 301. In some embodiments. the scale factor computed according to the maximum absolute value may be stored in registers or other non-transitory machine-readable storage. This register-based storage enables efficient reuse of the scale factors during quantization and downstream operations, minimizing memory latency and improving throughput. For example, in dynamic quantization layers of the machine-learning architecture 300, each token's scale factor is computed and stored in a register, allowing the quantization layer 305 to apply the corresponding scale factor to the BF15 input tensor 301 in a per-token manner.

The quantization layer 305 generates the scaled integer values for the input tensor 301 in a lower-precision data type using the adjusted range. The quantization layer 305 uses the adjusted range as a scale that the quantization layer 305 applies against the tensor values 301 to generate the quantized version of the input tensor 301 in the lower-precision data format. Using the maximum absolute value for the tokens of the input tensor 301, the quantization layer 305 determines and applies a scaling factor for scaling the values of the input tensor 301, where the maximum absolute value maps to a maximum integer value available in the lower-precision data. For example, if the maximum absolute value is ‘20’ for the tokens of the 301, then the quantization layer 305 determines a scale factor for scaling the values of the input tensor 301 such that ‘20’ maps to the maximum integer value of the lower-precision data type (e.g., 127 for INT8).

FIG. 4 is an example dataflow amongst components of portion of a mixed-precision transformer 400 for performing convolution operations, according to embodiments. The mixed-precision transformer 400 may be implemented by one or more processors of an automated device, such as an ego computing device (e.g., ego computing device 141), an analytics server (e.g., analytics server 110a), or other computing systems configured to execute machine-learning models. These processors may include INT8 MAC units and FP32 SIMD processors though embodiments are not so limited and may include, for example, INT4 MAC units, INT8 MAC units, INT15 MAC units, and INT16 MAC units, among others. The portions of the mixed-precision transformer 400 include an input tensor 401 or vector, a weight value 403 (or weight tensor), and a convolution layer 405. The mixed-precision transformer 400 shows convolution operations according to two scale factors, a scaling factor (e.g., S_Input) and weighting factor (e.g., S_W), which represent the scaling of the entire tensors 401 of a given shape or dimension. The input tensor 401 and the weight value 403 (S_Input) are each associated with a single global scale factor (S_W), which may be applied uniformly across the entire tensor 401. These scale factors may be derived from higher-precision representations (e.g., BF15 or FP32) and used to quantize the tensors to INT8 format.

In the quantization operations, the mixed-precision transformer 400 applies the first scaling factor to the input tensor 401 and the second scaling factor to the weight 403, resulting in the scaled input tensor 401 and the scaled weight value 403, which the mixed-precision transformer 400 feeds to the convolution layer 405. These quantized tensors are then provided to the convolution layer 405, which performs a convolution operation using INT8 MAC units.

The convolution layer 405 may execute convolution operations to perform matrix multiplication operations (e.g., as in matrix multiplication layers 214), where the matrix multiplication operations may be operational components of attention mechanisms of the transformer 400 architecture.

FIG. 5 is an example dataflow amongst components of portions of a mixed-precision transformer 500 for performing convolution operations, according to embodiments. The mixed-precision transformer 500 may be implemented by one or more processors of an automated device, such as an ego computing device (e.g., ego computing device 141), an analytics server (e.g., analytics server 110a), or other computing systems configured to execute machine-learning models. These processors may include INT8 MAC units and FP32 SIMD processors though embodiments are not so limited and may include, for example, INT4 MAC units, INT8 MAC units, INT15 MAC units, and INT16 MAC units, among others. The portions of the mixed-precision transformer 500 include input tensors 501a-501c or vectors (generally referred to as input tensors 501), weighting values 503a-503c (generally to as weighting values 503), convolution layers 505a-505c (generally referred to as convolution layers 505), and sum reduction layer 507.

The mixed-precision transformer 500 splits the input tensors 501 and executes corresponding convolution layers 505. In the quantization operations, the mixed-precision transformer 500 employs a set of scaling factors (e.g., S_Input0, S_Input1, S_Input2) for the input tensors 501 and a set of scaling factors (e.g., S_W0, S_W1, S_W3) for the scaling values 503. The mixed-precision transformer 500 then feeds the scaled input tensors 501 and the scaled weighting values 503 to the corresponding convolution layers 505, allowing for improved quantization performance at a cost of the sum reduction at the sum reduction layer 507. By splitting the input tensor 501 and applying different scale factors, the convolution operations the different convolution layers 505 help manage outliers and vary data distributions, providing more precise quantization or matrix multiplication results. In some implementations, for example, the input tensor 501 and the weight tensor 503 are each divided into multiple data blocks. Each block is associated with its own scale factor (e.g., S_Input0, S_Input1, S_Input2 for input blocks and S_W0, S_W1, S_W3 for weight blocks), which may be derived from higher-precision representations (e.g., BF15 or FP32) and used to quantize the blocks to INT8 format. The mixed-precision transformer 500 applies the corresponding scale factors to each input and weight block, resulting in multiple scaled input tensors 501a-501c and scaled weight tensors 503a-503c

In some cases, the convolution layers 505 may execute the convolution operations to facilitate dynamic quantization by applying the scale factors to different segments of the input tensor 501. In some cases, the convolution layers 505 may execute convolution operations to perform matrix multiplication operations (e.g., as in matrix multiplication layers 214), where the matrix multiplication operations may be operational components of attention mechanisms of the transformer 500 architecture. As an example, each convolution layer 505a-505c receives a pair of corresponding quantized input blocks and weight blocks and performs a convolution operation using INT8 MAC units. These convolution operations may be implemented as the matrix multiplication operations (e.g., as in matrix multiplication layers 214), and may serve as the operational components of the attention mechanisms or feedforward layers of the transformer 500 architecture.

The outputs of the convolution layers 505a-505c are provided to the sum reduction layer 507. The sum reduction layer 507 performs a sum reduction operation on the outputs of the convolution layers 505. Generally, sum reduction in the context of convolution operations refers to the process of summing the results of the convolution operations of the convolution layers 505 to produce a final output. In some cases, for example, the sum reduction layer 507 performs a sum reduction operation to aggregate the outputs of the individual block-wise convolutions of the convolution layers 505 into a single output tensor. As an example, the mixed-precision transformer 500 divides the input tensors 501 as smaller segments or blocks and executes the convolution operations by the convolution layers 505 on each input tensor 501a-501c separately. After performing the convolution operations on the individual segments or blocks of the input tensors 501a-501c, the convolution layers 505 generate and output results and the sum reduction layer 507 generates a sum of the output results to produce the final output.

As mentioned, in some embodiments, machine-learning architecture 500 may divide or split the tensors 501 into tiles or blocks for block-wise quantization. This tiling operation defines how the tensor 501 is partitioned into smaller data blocks along one or more dimensions, such as spatial dimensions (e.g., height, width), channel dimensions, or depth dimensions. Each tile or block may then be associated with a distinct scale factor (e.g., block-scale factor, channel scale factor), enabling various forms and granularity for quantization (e.g., per-token scale and quantization, per-channel scale and quantization, per-block scale and quantization). For example, the input tensor 501 and weight tensor 503 are split into multiple segments or blocks, each of which is quantized independently.

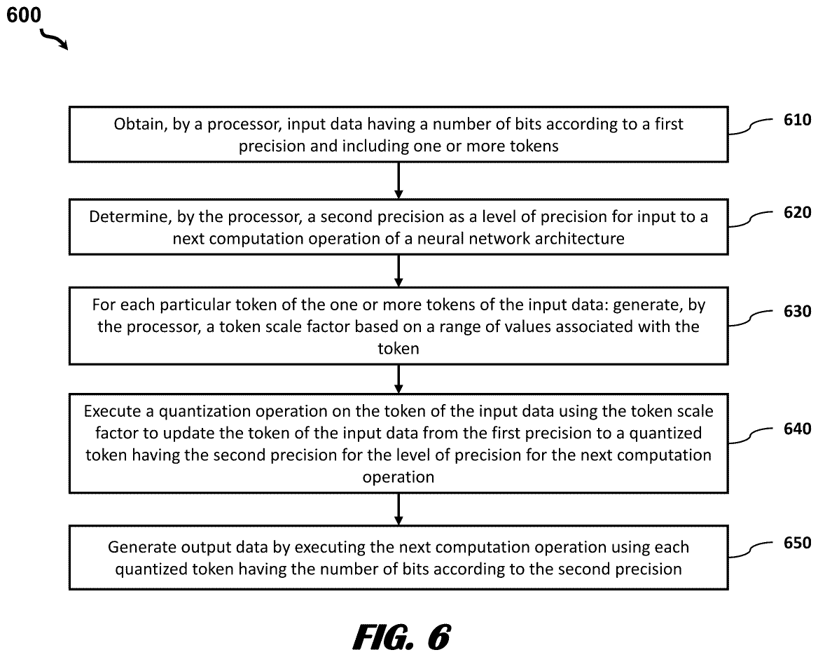

FIG. 6 is a flowchart of an example method 600 for processing sensor data using a mixed-precision transformer of a machine-learning architecture. At operation 610, a processor obtains input data (e.g., sensor data from a sensor of a robotic device), the input data having a number of bits according to a first precision. The input data includes or may be tokenized into one or more tokens.

At operation 620, the processor determines a second precision as a level of precision for input to a next computation operation of a neural network architecture. At operation 630, for each particular token of the one or more tokens of the input data, the processor generates a token scale factor based on a range of values associated with the particular token.

At operation 640, for each particular token of the one or more tokens, the processor executes a quantization operation on the token of the input data using the token scale factor. In executing the quantization operation, the processor may update the token of the input data from the first precision to a quantized token having the second precision for the level of precision for the next computation operation. At operation 650, the processor generates output data using the next computation operation and based upon the quantized tokens as updated or generated from the one or more tokens. The processor generates the output data by executing the next computation operation using each quantized token having the number of bits according to the second precision.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
obtaining, by a processor, input data having a number of bits according to a first precision and including one or more tokens;
determining, by the processor, a second precision as a level of precision for input to a next computation operation of a neural network architecture;
for each particular token of the one or more tokens of the input data:
generating, by the processor, a token scale factor based on a range of values associated with the token; and
executing, by the processor, a quantization operation on the token of the input data using the token scale factor to update the token of the input data from the first precision to a quantized token having the second precision for the level of precision for the next computation operation; and
generating, by the processor, output data by executing the next computation operation using each quantized token having the number of bits according to the second precision.

2. The method of claim 1, further comprising
generating, by the processor, a channel scale factor for each channel of one or more channels of a tensor; and
for each channel of the tensor, applying, by the processor, the channel scale factor according to the second precision.

3. The method of claim 2, further comprising, for each channel of the one or more channels of the tensor:
determining, by the processor, a maximum absolute value amongst a plurality of values of the input data in the channel; and
determining, by the processor, the channel scale factor based upon a range of values amongst the plurality of values of the input data in the channel using the maximum absolute value of the input data in the channel.

4. The method of claim 1, further comprising determining, by the processor, the level of precision for the input data based on at least one of: a signal-to-noise ratio of the input data, a loss function associated with a training process of the neural network architecture, or a computational constraint of a hardware accelerator.

5. The method of claim 1, further comprising:
extracting, by the processor, the one or more tokens from the input data.

6. The method of claim 1, further comprising, during a training phase of the neural network architecture:
obtaining, by the processor, a training data having the first precision;
executing, by the processor, the quantization operation on the training data according to the second precision to update the number of bits of the training data from the first precision to the second precision;
generating, by the processor, predicted output data of the next computation operation based upon the training data, by executing the next computation operation using the training data having the number of bits according to the second precision; and
updating, by the processor, one or more parameters of the neural network architecture having the next computation operation based on a loss value between the predicted output data and a training label associated with the training data.

7. The method of claim 1, wherein the processor executes the next computation operation using an accelerator including at least one of an integer multiply-accumulate (MAC) unit or a single instruction multiple data (SIMD) processor.

8. The method of claim 1, further comprising:
generating, by the processor, a plurality of data blocks from the input data based upon a tiling configuration of a tensor along one or more dimensions of the tensor, each data block of the input data includes a subset of values within the tensor defined along the one or more dimensions of the tensor; and
for each data block of the plurality of data blocks, applying, by the processor, a block scale factor to the data block based upon a range of values amongst the subset of values of the data block according to the second precision.

9. The method of claim 8, further comprising, for each data block of the plurality data blocks:
determining, by the processor, a maximum absolute value amongst the subset of values of the input data in the data block; and
determining, by the processor, the block scale factor based upon the range of values amongst the subset of values of the input data in the data block using the maximum absolute value of the data block.

10. The method of claim 1, further comprising storing, by the processor, each token scale factor into a non-transitory machine-readable storage.

11. A system comprising:
a processor configured to:
obtain input data having a number of bits according to a first precision and including one or more tokens;
determine a second precision as a level of precision for input to a next computation operation of a neural network architecture;
for each particular token of the one or more tokens of the input data:
generate a token scale factor based on a range of values associated with the token; and
execute a quantization operation on the token of the input data based upon using the token scale factor to update the token of the input data from the first precision to a quantized token having the second precision for the level of precision for the next computation operation; and
generate output data by executing the next computation operation using each quantized token having the number of bits according to the second precision.

12. The system of claim 11, wherein the processor is further configured to:
generate a channel scale factor for each channel of one or more channels of a tensor; and
for each channel, apply the channel scale factor to the channel according to the second precision.

13. The system of claim 12, wherein the processor is further configured to:
for each channel of the one or more channels of the tensor:
determine a maximum absolute value amongst a plurality of values of the input data in the channel; and
determine the channel scale factor based upon a range of values using the maximum absolute value.

14. The system of claim 11, wherein the processor is further configured to determine the level of precision based on at least one of: a signal-to-noise ratio of the input data, a loss function associated with a training process of the neural network architecture, or a computational constraint of a hardware accelerator.

15. The system of claim 11, wherein the processor is further configured to:
extract the one or more tokens from the input data.

16. The system of claim 11, wherein the processor is further configured to:
during a training phase of the neural network architecture:
obtain training data having the first precision;
execute the quantization operation on the training data according to the second precision;
generate predicted output data of the next computation operation using the training data having the second precision; and
update one or more parameters of the neural network architecture based on a loss value between the predicted output data and a training label.

17. The system of claim 11, wherein the processor is configured to execute the next computation operation using an accelerator including at least one of an integer multiply-accumulate (MAC) unit or a single instruction multiple data (SIMD) processor.

18. The system of claim 11, wherein the processor is further configured to:
generate a plurality of data blocks from the input data based upon a tiling configuration of a tensor along one or more dimensions of the tensor, each data block of the input data includes a subset of values within the tensor defined along the one or more dimensions of the tensor; and
for each data block of the plurality of data blocks, apply a block scale factor to the data block based upon a range of values amongst the subset of values of the data block according to the second precision.

19. The system of claim 18, wherein the processor is further configured to:
for each data block of the plurality data blocks:
determine a maximum absolute value amongst the subset of values of the input data in the data block; and
determine the block scale factor based upon the range of values amongst the subset of values of the input data in the data block using the maximum absolute value of the data block.

20. The system of claim 11, wherein the processor is further configured to store each token scale factor into a non-transitory machine-readable storage.
